(19) United States
(12) Patent Application Publication
(10) Pub. No.: US 2026/0219562 A1
(43) Pub. Date: Jul. 30, 2026

(54) PROJECTION APPARATUS, CONTROL METHOD, AND CONTROL PROGRAM

(71) Applicant: FUJIFILM Corporation, Tokyo (JP)

(72) Inventors: Kazuki INOUE, Saitama-shi (JP); Akihiro ISHIZUKA, Saitama-shi (JP); Yasuyuki MIYATA, Saitama-shi (JP)

(73) Assignee: FUJIFILM Corporation, Tokyo (JP)

(21) Appl. No.: 19/457,840

(22) Filed: Jan. 23, 2026

(30) Foreign Application Priority Data
Jan. 29, 2025 (JP) 2025-012988

(51) Int. Cl. G03B 21/14; G03B 21/20

(52) U.S. Cl. CPC G03B 21/142; G03B 21/208

(57) ABSTRACT

A projection apparatus includes: a body portion that performs projection through a projection lens; and a processor. The processor is configured to: control, in a first temperature range, a focus position of a projection image in accordance with first temperature characteristic information indicating a relationship between the focus position and a temperature of the body portion and second temperature characteristic information indicating a relationship between the focus position and a temperature of the projection lens; and control, in a second temperature range, the focus position in accordance with temperature characteristic information of either the first temperature characteristic information or the second temperature characteristic information.

### CROSS-REFERENCE TO RELATED APPLICATIONS

This application is based on and claims priority under 35 USC 119 from Japanese Patent Application No. 2025-012988 filed on Jan. 29, 2025, the contents of which are incorporated herein by reference.

### BACKGROUND OF THE INVENTION

### 1. Field of the Invention

The present invention relates to a projection apparatus, a control method, and a storage medium.

### 2. Description of the Related Art

JP2012-181339A discloses a projector including a storage portion that stores a reference moving amount from a set position set on an optical axis of a projection lens to a reference position to which a focus lens is moved based on an input operation, and a reference temperature when the focus lens is moved to the reference position, and a controller that, in returning the focus lens from a position at which the focus lens is retracted at a time of a reset, controls a driving portion to move the focus lens from the set position by a moving amount obtained by adding a correction moving amount corresponding to a difference between a temperature at the time of the reset and the reference temperature to the reference moving amount.

JP2021-117310A discloses a lens unit attachable to and detachable from a projection type display device, the lens unit including driving means for moving a focus position, identification means for identifying a type of the projection type display device, storage means for storing function information for correcting the focus position, and determination means for determining one function from the function information based on the type of the projection type display device.

JP2015-152722A discloses an interchangeable lens device that is detachably mounted on a projection display device and can communicate with the projection display device, the interchangeable lens device including an optical projection system, storage means for storing information related to a defocus level in a predetermined state for the projection display device and the optical projection system, detection means for detecting a state of the optical projection system, correction means for correcting the information in a case where the state of the optical projection system is different from the predetermined state, and communication means for transmitting the information to the projection display device.

### SUMMARY OF THE INVENTION

One embodiment according to the disclosed technology provides a projection apparatus, a control method, and a storage medium that can reduce deterioration in projection image quality.

(1)

A projection apparatus comprises a body portion that performs projection through a projection lens, and a processor, in which the processor is configured to control, in a first temperature range, a focus position of a projection image in accordance with first temperature characteristic information indicating a relationship between the focus position and a temperature of the body portion and second temperature characteristic information indicating a relationship between the focus position and a temperature of the projection lens, and control, in a second temperature range, the focus position in accordance with temperature characteristic information of any one of the first temperature characteristic information or the second temperature characteristic information.

(2)

In the projection apparatus according to (1), the first temperature characteristic information may indicate a relationship between a change in the temperature of the body portion and a change in the focus position, and the second temperature characteristic information may indicate a relationship between a change in the temperature of the projection lens and a change in the focus position.

(3)

In the projection apparatus according to (2), the processor may be configured to control, in the first temperature range, the focus position based on a first change in the focus position based on the change in the temperature of the body portion and the first temperature characteristic information and a second change in the focus position based on the change in the temperature of the projection lens and the second temperature characteristic information, and control, in the second temperature range, the focus position in accordance with a change of any one of the first change or the second change.

(4)

In the projection apparatus according to any one of (1) to (3), the processor may be configured to control the focus position to reduce an amount of shift in the focus position corresponding to a change in at least one of the temperature of the body portion or the temperature of the projection lens.

(5)

In the projection apparatus according to (4), the processor may be configured to reduce the amount of shift from a first focus position of the projection image set by a user.

(6)

In the projection apparatus according to (5), the processor may be configured to control the focus position in a case where the amount of shift from the first focus position exceeds a first value.

(7)

In the projection apparatus according to (6), the first value may be a value corresponding to a depth of field of the projection.

(8)

In the projection apparatus according to (7), the processor may be configured to control, in a first period, the focus position in a case where the amount of shift from the first focus position exceeds the first value, and control, in a second period, the focus position in a case where the amount of shift from the first focus position exceeds a second value that is greater than the first value.

(9)

In the projection apparatus according to (8), the second period may be a period after the first period.

(10)

In the projection apparatus according to (9), the first period may be a period from a start of the body portion to stabilization of the temperature of the body portion.

(11)

In the projection apparatus according to (9) or (10), the body portion may include a light source device, and the processor may be configured to set the first period and the second period in accordance with an output state of the light source device.

(12)

In the projection apparatus according to any one of (1) to (11), the processor may be configured to control the focus position based on a pixel value of image data used for the projection.

(13)

In the projection apparatus according to (12), the processor may be configured to control the focus position based on the pixel value weighted in accordance with a position in an image indicated by the image data.

(14)

In the projection apparatus according to (12) or (13), the processor may be configured to control the focus position based on an optical shift position in the projection.

(15)

In the projection apparatus according to any one of (12) to (14), the processor may be configured to control the focus position in a case where a transition in the pixel value satisfies a first condition.

(16)

A control method comprises, via a processor of a projection apparatus including a body portion that performs projection through a projection lens, and the processor, controlling, in a first temperature range, a focus position of a projection image in accordance with first temperature characteristic information indicating a relationship between the focus position and a temperature of the body portion and second temperature characteristic information indicating a relationship between the focus position and a temperature of the projection lens, and controlling, in a second temperature range, the focus position in accordance with temperature characteristic information of any one of the first temperature characteristic information or the second temperature characteristic information.

(17)

A non-transitory computer-readable storage medium storing a control program that causes a processor of a projection apparatus including a body portion that performs projection through a projection lens, and the processor, to execute a process comprising controlling, in a first temperature range, a focus position of a projection image in accordance with first temperature characteristic information indicating a relationship between the focus position and a temperature of the body portion and second temperature characteristic information indicating a relationship between the focus position and a temperature of the projection lens, and controlling, in a second temperature range, the focus position in accordance with temperature characteristic information of any one of the first temperature characteristic information or the second temperature characteristic information.

According to the present invention, a projection apparatus, a control method, and a storage medium that can reduce deterioration in projection image quality can be provided.

### BRIEF DESCRIPTION OF THE DRAWINGS

FIG. 1 is a diagram showing a projection apparatus 10 as an example of an embodiment.

FIG. 2 is a schematic diagram showing an example of an internal configuration of a projection portion 1.

FIG. 3 is a schematic diagram showing an example of an exterior of the projection apparatus 10.

FIG. 4 is a schematic cross-sectional view of a projection lens 106 of the projection apparatus 10 shown in FIG. 3.

FIG. 5 is a diagram showing an example of a relationship between a temperature and a focus position of the projection apparatus 10.

FIG. 6 is a diagram showing an example of temperature-focus position characteristics of a body portion 101 and the projection lens 106.

FIG. 7 is a diagram showing another example of the temperature-focus position characteristics of the body portion 101 and the projection lens 106.

FIG. 8 is a flowchart showing an example of processing performed by a control device 4.

FIG. 9 is a diagram showing an example of controlling the focus position in accordance with a transition in the temperature of the projection apparatus 10.

FIG. 10 is a diagram showing another example of controlling the focus position in accordance with the transition in the temperature of the projection apparatus 10.

FIG. 11 is a diagram showing an example of a change in the focus position corresponding to transitions in temperatures of the body portion 101 and the projection lens 106.

FIG. 12 is a diagram showing another example of a change in the focus position corresponding to the transitions in the temperatures of the body portion 101 and the projection lens 106.

FIG. 13 is a flowchart showing another example of the control performed by the control device 4.

FIG. 14 is a diagram showing an example of a tracking control of the focus position corresponding to an amount of shift in the focus position.

FIG. 15 is a diagram showing another example of the tracking control of the focus position corresponding to the amount of shift in the focus position.

FIG. 16 is a diagram showing an example of a difference in the transition in the temperature of the projection apparatus 10 depending on an output state of a light source 21.

FIG. 17 is a flowchart showing an example of controlling the focus position based on pixel values of image data used for projection.

FIG. 18 is a diagram showing an example of weighting pixel values corresponding to an area of the image data.

FIG. 19 is a diagram showing an example of weighting pixel values corresponding to an optical shift position in the projection.

FIG. 20 is a diagram for describing an example of controlling the focus position based on a transition in the pixel values of the image data.

FIG. 21 is a flowchart showing an example of processing of providing notification of a shift in the focus position caused by the transition in the temperature.

FIG. 22 is a diagram showing an example of notification of a shift in the focus position caused by the transition in the temperature.

FIG. 23 is a diagram showing another example of notification of a shift in the focus position caused by the transition in the temperature.

FIG. 24 is a diagram showing another example of the exterior configuration of the projection apparatus 10.

FIG. 25 is a cross-sectional view of the projection lens 106 of the projection apparatus 10 shown in FIG. 24.

### DESCRIPTION OF THE PREFERRED EMBODIMENTS

Hereinafter, an example of an embodiment of the present invention will be described with reference to the drawings.

### Projection Apparatus 10 as Embodiment

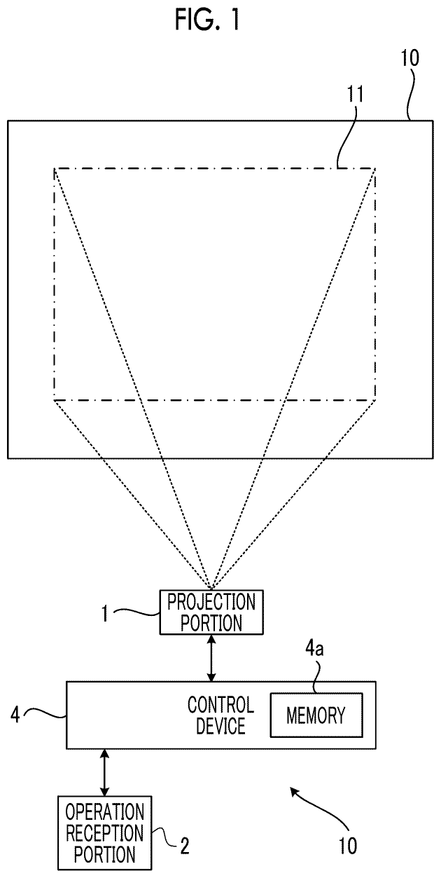

FIG. 1 is a diagram showing a projection apparatus 10 as an example of the embodiment. The projection apparatus 10 comprises a projection portion 1, a control device 4, and an operation reception portion 2.

The projection portion 1 is composed of, for example, a liquid crystal projector or a projector using liquid crystal on silicon (LCOS). Hereinafter, the projection portion 1 will be described as a liquid crystal projector.

The control device 4 is a control device that controls projection performed by the projection apparatus 10. The control device 4 is a device including a controller composed of various processors, a communication interface (not shown) for communicating with each portion, and a memory 4a such as a hard disk, a solid-state drive (SSD), or a read-only memory (ROM) and controls the projection portion 1 in an integrated manner. A processor that can constitute the control device 4 will be described later.

The operation reception portion 2 detects an instruction from a user by receiving various operations from the user. The operation reception portion 2 may be a button, a key, a joystick, or the like provided in the control device 4 or may be a reception portion or the like that receives a signal from a remote controller for remotely operating the control device 4.

A projection object 6 is an object such as a screen or a wall including a projection surface on which a projection image is displayed by the projection portion 1. In the example of the projection object 6 shown in FIG. 1, the projection surface of the projection object 6 is a rectangular plane. Upper, lower, left, and right sides of the projection object 6 in FIG. 1 are upper, lower, left, and right sides of the actual projection object 6.

A projection range 11 illustrated by a dot-dashed line is a region irradiated with projection light by the projection portion 1 in the projection object 6. In the example shown in FIG. 1, the projection range 11 has a rectangular shape. The projection range 11 is a part or the whole of a projectable range to which the projection can be performed by the projection portion 1.

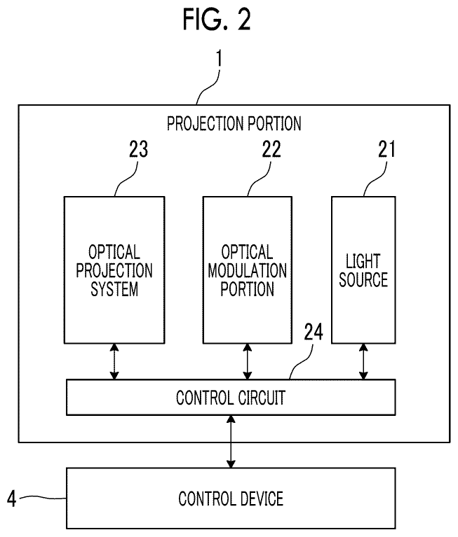

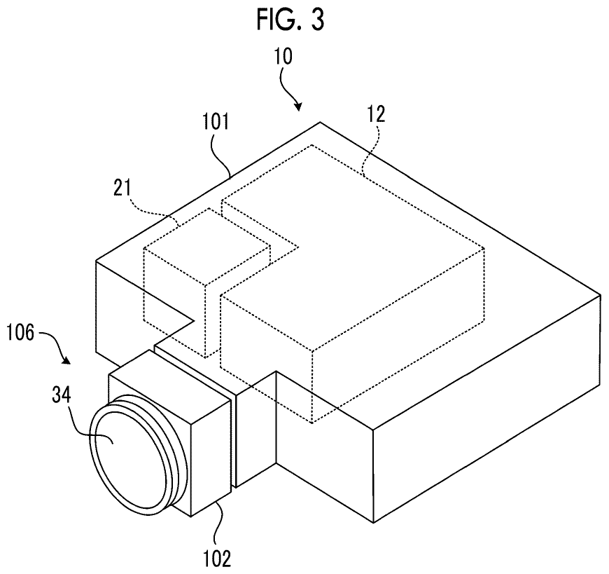

The projection portion 1, the control device 4, and the operation reception portion 2 are implemented by, for example, one device (for example, see FIGS. 2 and 3). Alternatively, the projection portion 1, the control device 4, and the operation reception portion 2 may be separate devices that cooperate with each other through communication.

### Internal Configuration of Projection Portion 1

FIG. 2 is a schematic diagram showing an example of an internal configuration of the projection portion 1. As shown in FIG. 2, the projection portion 1 of the projection apparatus 10 shown in FIG. 2 comprises a light source 21, an optical modulation portion 22, an optical projection system 23, and a control circuit 24. The light source 21 includes a light-emitting element such as a laser or a light-emitting diode (LED) and is, for example, a light source device that emits white light.

The optical modulation portion 22 is composed of three liquid crystal panels (optical modulation elements) that emit each color image by modulating, based on image information, light of each color emitted from the light source 21 and separated into three colors including red, blue, and green by a color separation mechanism, not shown, and a dichroic prism that combines each color image emitted from the three liquid crystal panels and emits the combined color image in the same direction. Each color image may be emitted by providing filters of red, blue, and green in the three liquid crystal panels, respectively, and modulating the white light emitted from the light source 21 via each liquid crystal panel.

Light from the light source 21 and the optical modulation portion 22 is incident on the optical projection system 23. The optical projection system 23 is composed of, for example, a relay optical system including at least one lens. Light that has passed through the optical projection system 23 is projected to the projection object 6.

In the projection object 6, a region irradiated with light transmitted through the whole range of the optical modulation portion 22 is the projectable range to which the projection can be performed by the projection portion 1. In the projectable range, a region irradiated with light actually transmitted from the optical modulation portion 22 is a projection range (projection range 11a) of the projection portion 1. For example, in the projectable range, a size, a position, and a shape of the projection range of the projection portion 1 are changed by controlling a size, a position, and a shape of a region through which light is transmitted in the optical modulation portion 22.

The control circuit 24 projects an image based on display data to the projection object 6 by controlling the light source 21, the optical modulation portion 22, and the optical projection system 23 based on the display data input from the control device 4. The display data input into the control circuit 24 is composed of three parts including red display data, blue display data, and green display data.

The control circuit 24 enlarges or reduces the projection range of the projection portion 1 by changing the optical projection system 23 based on an instruction input from the control device 4. The control device 4 may move the projection range of the projection portion 1 by changing the optical projection system 23 based on an operation of the user received by the operation reception portion 2.

The projection apparatus 10 also comprises a shift mechanism that mechanically or optically moves the projection range of the projection portion 1 while maintaining an image circle of the optical projection system 23. The image circle of the optical projection system 23 is a region in which the projection light incident on the optical projection system 23 correctly passes through the optical projection system 23 in terms of light fall-off, color separation, edge part curvature, and the like.

The shift mechanism is implemented by at least any of an optical system shift mechanism that performs optical system shifting, or an electronic shift mechanism that performs electronic shifting.

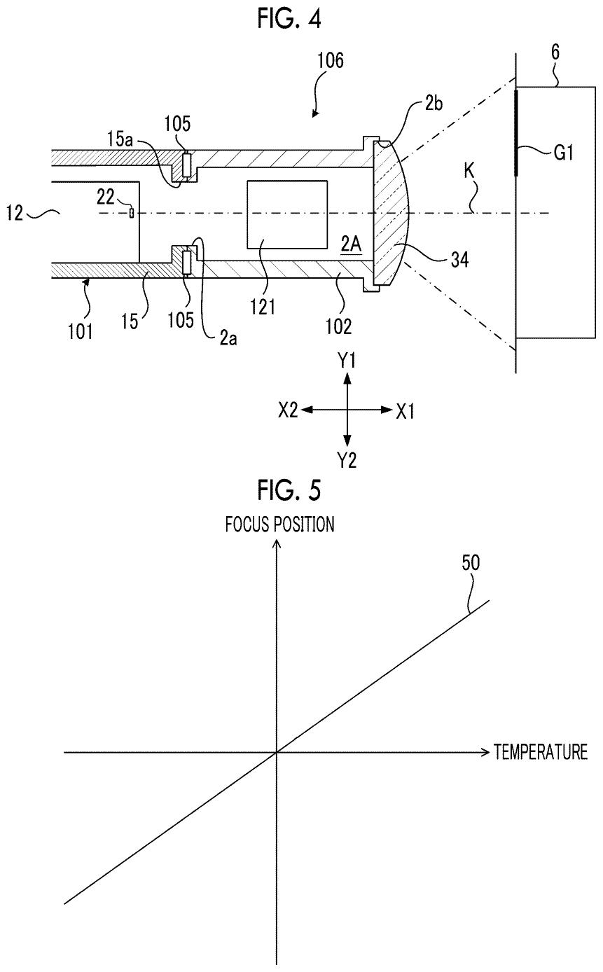

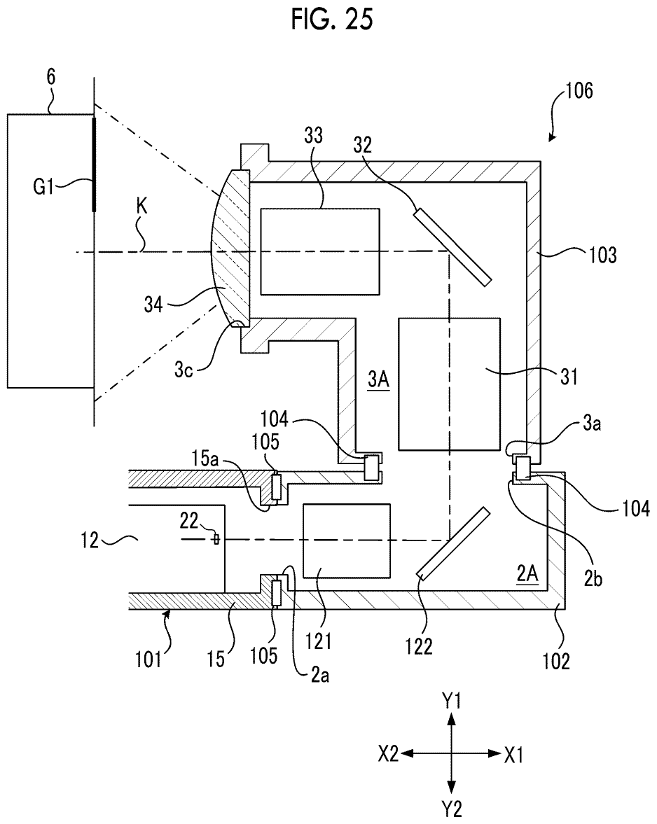

The optical system shift mechanism is, for example, a mechanism (for example, see FIGS. 4 and 25) that moves the optical projection system 23 in a direction perpendicular to an optical axis, or a mechanism that moves the optical modulation portion 22 in the direction perpendicular to the optical axis instead of moving the optical projection system 23. The optical system shift mechanism may move the optical projection system 23 and the optical modulation portion 22 in combination.

The electronic shift mechanism is a mechanism that pseudo-shifts the projection range by changing a range through which light is transmitted in the optical modulation portion 22.

The projection apparatus 10 may comprise a projection direction changing mechanism that moves the projection range together with the image circle of the optical projection system 23. The projection direction changing mechanism is a mechanism that changes a projection direction of the projection portion 1 by changing a direction of the projection portion 1 through mechanical rotation (for example, see FIG. 25).

### Exterior of Projection Apparatus 10

FIG. 3 is a schematic diagram showing an example of an exterior of the projection apparatus 10. FIG. 4 is a schematic cross-sectional view of a projection lens 106 of the projection apparatus 10 shown in FIG. 3. FIG. 4 shows a cross section in a plane along an optical path of light emitted from a body portion 101 shown in FIG. 3.

As shown in FIG. 3, the projection apparatus 10 comprises the body portion 101 and the projection lens 106 provided to protrude from the body portion 101. In the configuration shown in FIG. 3, the operation reception portion 2, the control device 4, and the light source 21, the optical modulation portion 22, and the control circuit 24 in the projection portion 1 are provided in the body portion 101. The optical projection system 23 of the projection portion 1 is provided in the projection lens 106.

The projection lens 106 comprises a first member 102 supported by the body portion 101. The projection lens 106 may be configured to be attachable to and detachable from the body portion 101 (in other words, configured to be interchangeable).

As shown in FIG. 4, the body portion 101 includes a housing 15 in which an opening 15a for passing light is formed in a part connected to the projection lens 106.

As shown in FIG. 3, the light source 21 and an optical modulation unit 12 including the optical modulation portion 22 (see FIG. 2) that generates an image by spatially modulating light emitted from the light source 21 based on input image data are provided in the housing 15 of the body portion 101. Light emitted from the light source 21 is incident on the optical modulation portion 22 of the optical modulation unit 12 and is spatially modulated and emitted by the optical modulation portion 22.

As shown in FIG. 4, the image formed by the light spatially modulated by the optical modulation unit 12 passes through the opening 15a of the housing 15 and is incident on the projection lens 106 and projected to the projection object 6. Accordingly, an image G1 is visible from an observer.

The projection lens 106 is an optical unit comprising the first member 102 including a hollow portion 2A connected to an inside of the body portion 101, a first optical system 121 disposed in the hollow portion 2A, a lens 34, and a first shift mechanism 105.

The first member 102 is a member of which a cross-sectional external shape is, for example, a rectangular shape, in which an opening 2a and an opening 2b are formed in surfaces parallel to each other. The first member 102 is supported by the body portion 101 in a state where the opening 2a is disposed at a position facing the opening 15a of the body portion 101. Light emitted from the optical modulation portion 22 of the optical modulation unit 12 of the body portion 101 is incident into the hollow portion 2A of the first member 102 through the opening 15a and the opening 2a.

An incidence direction of the light incident into the hollow portion 2A from the body portion 101 will be referred to as a direction X1. A direction opposite to the direction X1 will be referred to as a direction X2. The direction X1 and the direction X2 will be collectively referred to as a direction X. A direction from the front to the back and a direction opposite thereto in FIG. 4 will be referred to as a direction Z. In the direction Z, the direction from the front to the back will be referred to as a direction Z1, and the direction from the back to the front will be referred to as a direction Z2.

A direction perpendicular to the direction X and the direction Z will be referred to as a direction Y. In the direction Y, an upward direction in FIG. 4 will be referred to as a direction Y1, and a downward direction in FIG. 4 will be referred to as a direction Y2. In the example in FIG. 4, the projection apparatus 10 is disposed such that the direction Y2 is a vertical direction.

In the example in FIG. 4, the optical projection system 23 shown in FIG. 2 is composed of the first optical system 121 and the lens 34. FIG. 4 shows an optical axis K of the optical projection system 23. The first optical system 121 and the lens 34 are disposed in this order from a side on which the optical modulation portion 22 is present along the optical axis K.

The first optical system 121 includes at least one lens and guides light incident on the first member 102 from the body portion 101 and traveling in the direction X1 to the lens 34.

The lens 34 is disposed in an end portion of the first member 102 on a side in the direction X1, in the form of closing the opening 2b formed in the end portion. The lens 34 projects light incident from the first optical system 121 to the projection object 6.

The first shift mechanism 105 is a mechanism for moving the optical axis K of the optical projection system (in other words, the projection lens 106) in a direction (the direction Y in FIG. 4) perpendicular to the optical axis K. Specifically, the first shift mechanism 105 is configured to change a position of the first member 102 in the direction Y with respect to the body portion 101. The first shift mechanism 105 may manually move the first member 102 or electrically move the first member 102.

FIG. 4 shows a state where the first member 102 is moved as far as possible to a side in the direction Y1 by the first shift mechanism 105. By moving the first member 102 in the direction Y2 via the first shift mechanism 105 from the state shown in FIG. 4, a relative position between a center of the image formed by the optical modulation portion 22 (in other words, a center of a display surface) and the optical axis K is changed, and the image G1 projected to the projection object 6 can be shifted (translated) in the direction Y2.

The first shift mechanism 105 may be a mechanism that moves the optical modulation portion 22 in the direction Y instead of moving the projection lens 106 in the direction Y. Even in this case, the image G1 projected to the projection object 6 can be moved in the direction Y.

Relationship between Temperature and Focus Position of Projection Apparatus 10

FIG. 5 is a diagram showing an example of a relationship between a temperature and a focus position of the projection apparatus 10. In FIG. 5, a horizontal axis denotes the temperature of the projection apparatus 10, and a vertical axis denotes the focus position of the projection image of the projection apparatus 10. A temperature-focus position characteristic 50 shows a relationship between the temperature and the focus position of the projection apparatus 10 in a case where a set value of the focus position in the projection apparatus 10 is constant.

The focus position for the projection of the projection apparatus 10 may change depending on the temperature of the projection apparatus 10. The temperature of the projection apparatus 10 changes depending on various factors such as a temperature of a space in which the projection apparatus 10 is installed. In particular, immediately after the projection apparatus 10 starts, a temperature of the light source 21 or the optical modulation unit 12 significantly increases because the light source 21 or the optical modulation unit 12 of the projection apparatus 10 starts operating, or a temperature of the optical projection system 23 significantly increases because the lens of the optical projection system 23 absorbs light energy of the projection light incident on the optical projection system 23.

Thus, for example, even in a case where the user performs focus adjustment (focusing) for the projection to the projection object 6 at the start of the projection apparatus 10, the temperature of the projection apparatus 10 may increase over time, and this may change the focus position. In this case, the projection image blurs, and projection image quality deteriorates. To eliminate this issue, the focus adjustment needs to be performed again.

The projection apparatus 10 appropriately controls the focus position to reduce deterioration in the projection image quality without performing the focus adjustment again.

### Temperature-Focus Position Characteristics of Body Portion 101 and Projection Lens 106

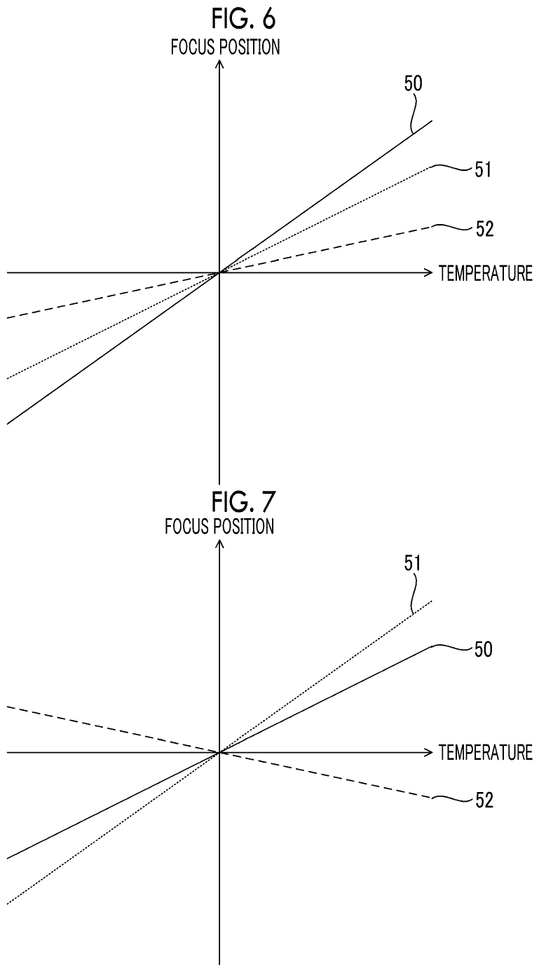

FIG. 6 is a diagram showing an example of temperature-focus position characteristics of the body portion 101 and the projection lens 106. The same parts as the parts shown in FIG. 5 will be designated by the same reference numerals in FIG. 6 and will not be described.

A temperature-focus position characteristic 51 shows a relationship between a temperature of the body portion 101 and the focus position of the projection image determined by a state of the body portion 101 in a case where the set value of the focus position in the projection apparatus 10 is constant. The temperature-focus position characteristic 51 is an example of first temperature characteristic information indicating a relationship between a change in the temperature of the body portion 101 and a change in the focus position.

A temperature-focus position characteristic 52 indicates a relationship between a temperature of the projection lens 106 and the focus position of the projection image determined by a state of the projection lens 106 in a case where the set value of the focus position in the projection apparatus 10 is constant. The temperature-focus position characteristic 52 is an example of second temperature characteristic information indicating a relationship between a change in the temperature of the projection lens 106 and a change in the focus position.

Both of the temperature of the body portion 101 and the temperature of the projection lens 106 affect the focus position of the projection apparatus 10. That is, the temperature-focus position characteristic 50 of the projection apparatus 10 is a characteristic obtained by combining the temperature-focus position characteristic 51 and the temperature-focus position characteristic 52. The memory 4a of the projection apparatus 10 stores information indicating the temperature-focus position characteristic 51 and the temperature-focus position characteristic 52.

FIG. 7 is a diagram showing another example of the temperature-focus position characteristics of the body portion 101 and the projection lens 106. The same parts as the parts shown in FIG. 5 will be designated by the same reference numerals in FIG. 7 and will not be described. While the example in FIG. 6 describes a case where the focus position shifts in the same direction in accordance with an increase in the temperature for both of the temperature-focus position characteristics 51 and 52, the present invention is not limited to such a case.

For example, as in the example in FIG. 7, the focus position may shift in the opposite directions in accordance with an increase in the temperature in the temperature-focus position characteristics 51 and 52, depending on the configuration of the projection apparatus 10 (characteristics and the like of the projection lens 106). Even in this case, the temperature-focus position characteristic 50 of the projection apparatus 10 is a characteristic obtained by combining the temperature-focus position characteristic 51 and the temperature-focus position characteristic 52.

### Processing Performed by Control Device 4

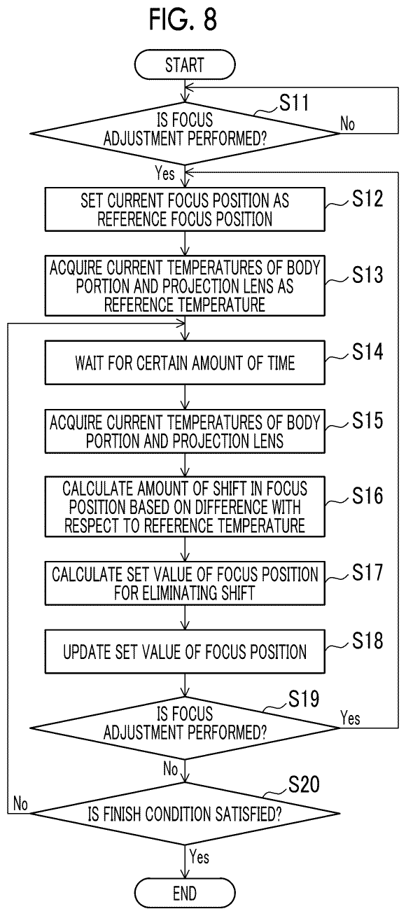

FIG. 8 is a flowchart showing an example of processing performed by the control device 4. The control device 4 executes, for example, the processing shown in FIG. 8 when, for example, the projection apparatus 10 starts.

First, the control device 4 determines whether the focus adjustment for the projection performed by the projection apparatus 10 is performed (step S11), and waits until the focus adjustment is performed (step S11: the loop of No). For example, the focus adjustment is performed in accordance with a user operation performed on the operation reception portion 2. The focus adjustment is also performed by controlling the control circuit 24 to drive a focus lens included in the optical projection system 23 via the control device 4.

In step S11, in a case where the focus adjustment is performed (step S11: Yes), the control device 4 sets the current (present) focus position as a reference focus position (step S12). The reference focus position is an example of a first focus position that is a focus position immediately after the user performs an operation of adjusting the focus position.

Next, the control device 4 acquires the current (present) temperatures of the body portion 101 and the projection lens 106 as a reference temperature (step S13). For example, the control device 4 acquires the temperature of the body portion 101 based on an output value of a temperature sensor provided in the body portion 101. The control device 4 also acquires an estimated value of the temperature of the projection lens 106 based on correspondence information (a correspondence table or function) between the output value of the temperature sensor provided in the body portion 101 and the temperature of the projection lens 106 and on the output value of the temperature sensor provided in the body portion 101, as the temperature of the projection lens 106. In a case where a temperature sensor is also provided in the projection lens 106, the control device 4 may acquire the temperature of the projection lens 106 based on an output value of this temperature sensor.

Next, the control device 4 waits for a certain amount of time (step S14). This certain amount of time is, for example, 10 seconds but is not limited thereto and can be changed, as appropriate. Next, the control device 4 acquires the current (present) temperatures of the body portion 101 and the projection lens 106 (step S15). A method of acquiring the temperatures in step S15 is the same as the method of acquiring the temperatures in step S13.

Next, the control device 4 calculates an amount of shift in the focus position of the projection image of the projection apparatus 10 based on a difference between the temperatures acquired in step S15 and the reference temperature acquired in step S13 (step S16). The amount of shift in the focus position is, for example, a value indicating an absolute amount of shift in the focus position and a direction of shift in the focus position. For example, an absolute value of the amount of shift in the focus position indicates the absolute amount of shift in the focus position, and a sign of the amount of shift in the focus position indicates the direction of shift in the focus position.

For example, the memory 4a of the control device 4 stores first correspondence information (a correspondence table or function) between a transition in the temperature of the body portion 101 and the direction of shift and the absolute amount of shift in the focus position corresponding to the temperature-focus position characteristic 51 of the body portion 101 shown in FIG. 6 (or FIG. 7). The control device 4 calculates a difference between the temperature of the body portion 101 acquired in step S15 and the reference temperature of the body portion 101 acquired in step S13 and calculates the direction of shift and the absolute amount of shift in the focus position of the projection image of the projection apparatus 10 from the reference focus position set in step S12 caused by the transition in the temperature of the body portion 101 based on the calculated difference and the first correspondence information.

The memory 4a of the control device 4 also stores second correspondence information (a correspondence table or function) between a transition in the temperature of the projection lens 106 and the direction of shift and the absolute amount of shift in the focus position corresponding to the temperature-focus position characteristic 52 of the projection lens 106 shown in FIG. 6 (or FIG. 7). The control device 4 calculates a difference between the temperature of the projection lens 106 acquired in step S15 and the reference temperature of the projection lens 106 acquired in step S13 and calculates the direction of shift and the absolute amount of shift in the focus position of the projection image of the projection apparatus 10 from the reference focus position set in step S12 caused by the transition in the temperature of the projection lens 106 based on the calculated difference and the second correspondence information.

The control device 4 calculates a total amount of shift in the focus position caused by the transition in the temperature of each of the body portion 101 and the projection lens 106 by adding a calculation result of the amount of shift in the focus position caused by the transition in the temperature of the body portion 101 and the amount of shift in the focus position caused by the transition in the temperature of the projection lens 106.

Next, based on the amount of shift in the focus position calculated in step S16, the control device 4 calculates the set value of the focus position for eliminating the shift in the focus position indicated by the amount of shift (step S17). The set value of the focus position is, for example, a control value of the focus lens included in the optical projection system 23. Next, the control device 4 updates the set value of the focus position with the set value calculated in step S17 (step S18).

Next, the control device 4 determines whether the focus adjustment for the projection performed by the projection apparatus 10 is performed again by the user (step S19). In a case where the focus adjustment is performed again (step S19: Yes), the control device 4 returns to step S12 and updates the reference focus position and the reference temperature.

In step S19, in a case where the focus adjustment is not performed again (step S19: No), the control device 4 determines whether a predetermined finish condition is satisfied (step S20). The finish condition is, for example, a condition that an operation of stopping the projection of the projection apparatus 10 is performed. Alternatively, the finish condition may be a condition that the temperature of the projection apparatus 10 reaches a stable steady state after the projection apparatus 10 starts.

In step S20, in a case where the finish condition is not satisfied (step S20: No), the control device 4 returns to step S14 and continues updating the set value of the focus position corresponding to the transition in the temperature. In a case where the finish condition is satisfied (step S20: Yes), the control device 4 finishes the series of processing.

Controlling Focus Position in Accordance with Transition in Temperature of Projection Apparatus 10

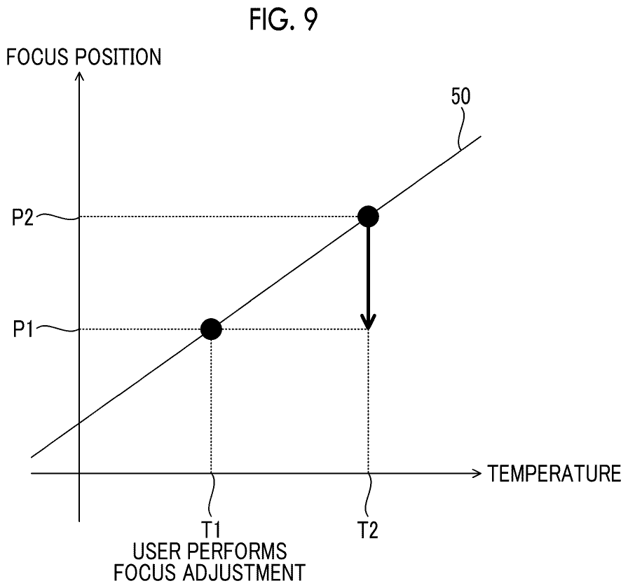

FIG. 9 is a diagram showing an example of controlling the focus position in accordance with a transition in the temperature of the projection apparatus 10. A horizontal axis in FIG. 9 denotes the temperature of the projection apparatus 10.

A temperature T1 when the focus adjustment is performed by the user is set as the reference temperature, and a focus position P1 immediately after the focus adjustment is set as the reference focus position.

After the user performs the focus adjustment, the temperature of the projection apparatus 10 changes from the temperature T1 to a temperature T2. A focus position P2 at this moment can be calculated based on the temperature-focus position characteristic 50, the focus position P1, the temperature T1, and the temperature T2.

Specifically, the control device 4 calculates the amount of shift in the focus position from the focus position P1 caused by the transition in the temperature of the body portion 101 based on the temperature-focus position characteristic 51 of the body portion 101, the temperature of the body portion 101 at the temperature T1, and the temperature of the body portion 101 at the temperature T2. The control device 4 also calculates the amount of shift in the focus position from the focus position P1 caused by the transition in the temperature of the projection lens 106 based on the temperature-focus position characteristic 52 of the projection lens 106, the temperature of the projection lens 106 at the temperature T1, and the temperature of the projection lens 106 at the temperature T2. The control device 4 calculates the focus position P2 based on the amount of shift in the focus position from the focus position P1 caused by the transition in the temperature of the body portion 101 and the amount of shift in the focus position from the focus position P1 caused by the transition in the temperature of the projection lens 106.

The control device 4 calculates the set value of the focus position for returning the focus position from the focus position P2 to the focus position P1 based on the calculated focus position P2 and returns the focus position to the focus position P1 by applying the calculated set value. Accordingly, even in a case where the temperature of the projection apparatus 10 transitions after the user performs the focus adjustment, the focus position can be maintained at the focus position P1 immediately after the user performs the focus adjustment.

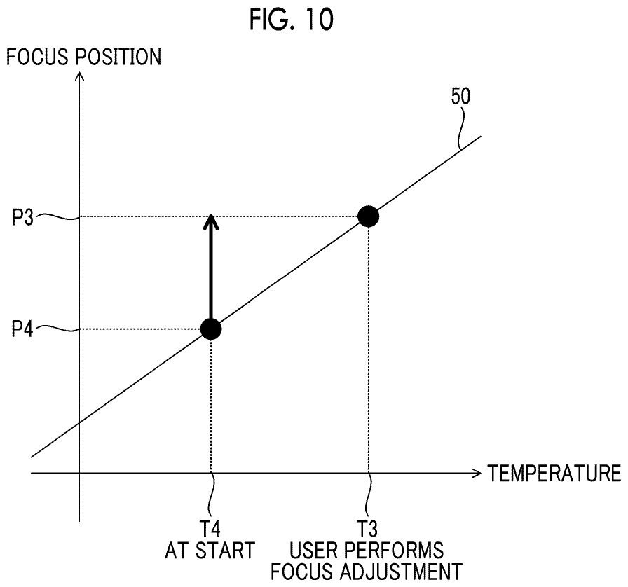

FIG. 10 is a diagram showing another example of controlling the focus position in accordance with the transition in the temperature of the projection apparatus 10. While the example in FIGS. 8 and 9 describes processing of setting the focus position after the user performs the focus adjustment after the projection apparatus 10 starts as the reference focus position, the control device 4 may store the set reference focus position and the set reference temperature in a non-volatile memory of the memory 4a and control the focus position using the reference focus position and the reference temperature at the subsequent start of the projection apparatus 10.

For example, a temperature T3 and a focus position P3 denote the temperature of the projection apparatus 10 and the focus position, respectively, immediately after the user performs the focus adjustment while the projection apparatus 10 starts. In this case, the control device 4 stores the temperature T3 (specifically, the temperature of the body portion 101 and the temperature of the projection lens 106) in the memory 4a as the reference temperature and stores the focus position P3 in the memory 4a as the reference focus position.

When the projection apparatus 10 stops, and then the projection apparatus 10 starts, the control device 4 reads out the reference temperature and the reference focus position because the reference temperature (temperature T3) and the reference focus position (focus position P3) are stored in the memory 4a. T4 denotes the temperature of the projection apparatus 10 at the start of the projection apparatus 10. A focus position P4 at this moment can be calculated based on the temperature-focus position characteristic 50, the focus position P3, the temperature T3, and the temperature T4.

Specifically, the control device 4 calculates the amount of shift in the focus position from the focus position P3 caused by the transition in the temperature of the body portion 101 based on the temperature-focus position characteristic 51 of the body portion 101, the temperature of the body portion 101 at the temperature T3, and the temperature of the body portion 101 at the temperature T4. The control device 4 also calculates the amount of shift in the focus position from the focus position P3 caused by the transition in the temperature of the projection lens 106 based on the temperature-focus position characteristic 52 of the projection lens 106, the temperature of the projection lens 106 at the temperature T3, and the temperature of the projection lens 106 at the temperature T4. The control device 4 calculates the focus position P4 based on the amount of shift in the focus position from the focus position P3 caused by the transition in the temperature of the body portion 101 and the amount of shift in the focus position from the focus position P3 caused by the transition in the temperature of the projection lens 106.

The control device 4 calculates the set value of the focus position for returning the focus position from the focus position P4 to the focus position P3 based on the calculated focus position P4 and returns the focus position to the focus position P3 by applying the calculated set value. Accordingly, the focus position P3 immediately after the user performs the focus adjustment during the previous start of the body portion 101 can be set as the focus position at the start of the body portion 101.

Thus, as long as a positional relationship between the projection apparatus 10 and the projection object 6 is maintained, the focus position immediately after the focus adjustment is performed in the past can be set at the second or subsequent start of the body portion 101 without causing the user to perform the focus adjustment.

The temperature of the projection apparatus 10 generally increases immediately after the start of the body portion 101. Thus, the temperature of the projection apparatus 10 in a case where the focus adjustment is performed by the user is generally different from the temperature at the start of the body portion 101. Meanwhile, according to the above control, even in a case where the temperature of the projection apparatus 10 in a case where the focus adjustment is performed in the past is different from the temperature at the start of the projection apparatus 10, the focus position immediately after the focus adjustment is performed in the past can be set.

### Change in Focus Position Corresponding to Transitions in Temperatures of Body Portion 101 and Projection Lens 106

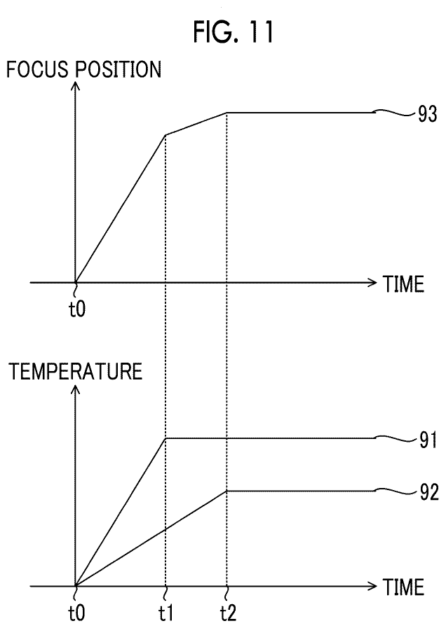

FIG. 11 is a diagram showing an example of a change in the focus position corresponding to the transitions in the temperatures of the body portion 101 and the projection lens 106. In FIG. 11, a horizontal axis denotes time, and a vertical axis denotes the temperature and the focus position of the projection apparatus 10. For example, time point t0 is a time point at which the projection apparatus 10 starts.

A transition in temperature 91 is a transition in the temperature of the body portion 101 over time. After the start of the projection apparatus 10, the temperature of the body portion 101 gradually increases because of heat generated by the light source 21 and the like and reaches a steady state in a case where the temperature reaches a certain temperature. In the example in FIG. 11, the temperature of the body portion 101 gradually increases from time point t0 at which the projection apparatus 10 starts, and reaches a steady state from time point t1.

A transition in temperature 92 is a transition in the temperature of the projection lens 106 over time. After the start of the projection apparatus 10, the temperature of the projection lens 106 gradually increases because of the incidence and the like of the projection light and reaches a steady state in a case where the temperature reaches a certain temperature. In the example in FIG. 11, the temperature of the projection lens 106 gradually increases from time point t0 at which the projection apparatus 10 starts, and reaches a steady state from time point t2.

In the example in FIG. 11, the temperature of the body portion 101 increases more rapidly than the temperature of the projection lens 106 after the start of the projection apparatus 10. The temperature of the body portion 101 reaches a steady state earlier than the temperature of the projection lens 106 (t1<t2). Accordingly, the temperature of the body portion 101 and the temperature of the projection lens 106 change at different rates and require different amounts of time to reach a steady state.

A transition in focus position 93 is a change in the focus position over time corresponding to the transitions in temperature 91 and 92. The focus position changes in accordance with the transitions in the temperatures of the body portion 101 and the projection lens 106.

Specifically, in a period from time point t0 to time point t1, the temperatures of both of the body portion 101 and the projection lens 106 increase. Thus, the focus position changes in accordance with the temperature-focus position characteristic 50 obtained by combining the temperature-focus position characteristic 51 of the body portion 101 and the temperature-focus position characteristic 52 of the projection lens 106. In this example, the focus position changes relatively rapidly in the period from time point t0 to time point t1.

Meanwhile, in a period from time point t1 to time point t2, the temperature of only the body portion 101 out of the body portion 101 and the projection lens 106 increases. Thus, the focus position changes in accordance with only the temperature-focus position characteristic 51 out of the temperature-focus position characteristic 51 of the body portion 101 and the temperature-focus position characteristic 52 of the projection lens 106. In this example, the focus position changes relatively gently in the period from time point t1 to time point t2.

In a period after time point t2, the temperatures of both of the body portion 101 and the projection lens 106 reach a steady state. Thus, the focus position also reaches a steady state.

In the projection apparatus 10, the focus position is controlled in accordance with the temperature-focus position characteristic 51 (the first temperature characteristic information) indicating the relationship between the focus position and the temperature of the body portion 101 and the temperature-focus position characteristic 52 (the second temperature characteristic information) indicating the relationship between the focus position and the temperature of the projection lens 106 in a first temperature range. The first temperature range is, for example, temperature ranges of the body portion 101 and the projection lens 106 in a period (for example, the period from time point t0 to time point t1) in which the temperatures of the body portion 101 and the projection lens 106 increase after the start of the body portion 101.

In the projection apparatus 10, the focus position is controlled in accordance with temperature characteristic information of any one of the temperature-focus position characteristic 51 (the first temperature characteristic information) or the temperature-focus position characteristic 52 (the second temperature characteristic information) in a second temperature range. The second temperature range is temperature ranges of the body portion 101 and the projection lens 106 in a period from convergence of the temperature of one of the body portion 101 or the projection lens 106 to convergence of the temperature of the other.

That is, in the first temperature range, the focus position is controlled based on a first change in the focus position based on the change in the temperature of the body portion 101 and the temperature-focus position characteristic 51, and a second change in the focus position based on the change in the temperature of the projection lens 106 and the temperature-focus position characteristic 52. In the second temperature range, the focus position is controlled in accordance with a change of any one of the first change or the second change.

Accordingly, as in the transition in focus position 93 shown in FIG. 11, the focus position is controlled at different rates between the period from time point t0 to time point t1 in which the temperatures of the body portion 101 and the projection lens 106 transform, and the period from time point t1 to time point t2 in which the temperature of only the body portion 101 out of the body portion 101 and the projection lens 106 transforms. Thus, the amount of shift in the focus position can be appropriately reduced in accordance with the transition in the temperature of each of the body portion 101 and the projection lens 106, and deterioration in the projection image quality can be reduced.

The control device 4 sets the focus position set by the user as the reference focus position (the first focus position) and controls the focus position such that the amount of shift in the focus position from the reference focus position is reduced. Accordingly, even in a case where the temperature of the body portion 101 or the projection lens 106 transitions, the focus position set by the user can be maintained.

In a case where the focus position is set again by the user while controlling the focus position based on the temperature of the body portion 101 or the projection lens 106, the control device 4 controls the focus position such that the focus position set again is set as a new reference focus position, and the amount of shift in the focus position from the new reference focus position is reduced. Accordingly, in a case where, for example, the positional relationship between the projection apparatus 10 and the projection object 6 changes, and the user sets the focus position again, the focus position set again can be maintained. In a case where the amount of shift in the focus position cannot be sufficiently reduced by controlling the focus position based on the temperature of the body portion 101 or the projection lens 106, the user can set the focus position again. Accordingly, the amount of shift in the focus position can be appropriately reduced, and deterioration in the projection image quality can be reduced.

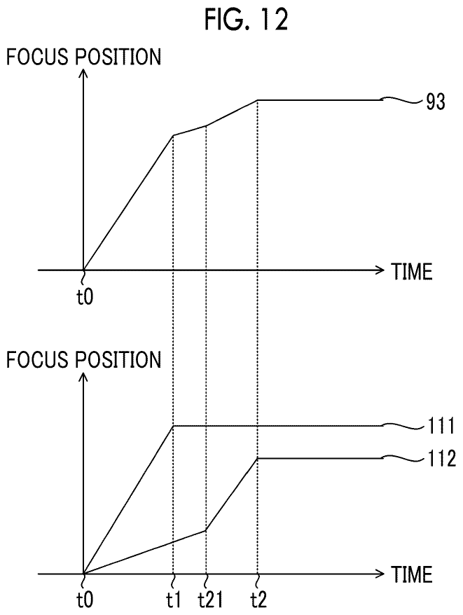

FIG. 12 is a diagram showing another example of a change in the focus position corresponding to the transitions in the temperatures of the body portion 101 and the projection lens 106. While the example in FIG. 11 describes a case where a change in the focus position caused by an increase in the temperature of each of the body portion 101 and the projection lens 106 occurs at a substantially constant rate, the present invention is not limited to such a case. For example, in the projection lens 106, optical members such as lenses are combined in a complicated manner, and a rate of change in the focus position caused by an increase in the temperature of the projection lens 106 after the incidence of the projection light on the projection lens 106 starts may not be constant.

In FIG. 12, a transition in focus position 111 is a change in the focus position over time caused by the transition in the temperature of the body portion 101 immediately after the start of the body portion 101. A transition in focus position 112 is a change in the focus position over time caused by the transition in the temperature of the projection lens 106 immediately after the start of the body portion 101.

In the example in FIG. 12, in a period from time point t0 at which the body portion 101 starts to time point t21, a change in the focus position caused by the transition in the temperature of the projection lens 106 is relatively gentle. Meanwhile, in a period from time point t21 to time point t2 at which the temperature of the projection lens 106 reaches a steady state, a change in the focus position caused by the transition in the temperature of the projection lens 106 is relatively rapid.

Such a change in the rate of change in the focus position may occur in a case where, for example, the projection lens 106 includes a first lens and a second lens, the first lens changes the focus position in a positive direction as the temperature increases, and the second lens changes the focus position in a negative direction as the temperature increases.

That is, in the period from time point t0 to time point t21, a change in the focus position caused by an increase in the temperature occurs in both the first lens and the second lens. However, the positive and negative changes in the focus position offset each other, and a change in the focus position as a whole is relatively gentle. Here, a change in the focus position caused by an increase in the temperature in the second lens converges at time point t21. In this case, in the period from time point t21 to time point t2, a change in the focus position caused by an increase in the temperature occurs in only the first lens out of the first lens and the second lens and is not offset by a change in the focus position caused by an increase in the temperature in the second lens. Thus, a change in the focus position as a whole is relatively rapid.

The transition in focus position 93 that is a change in the focus position of the projection apparatus 10 as a whole is obtained by combining the transitions in focus position 111 and 112. Thus, the rate of change changes in the period from time point t0 to time point t2. Even in such a case, the control performed by the control device 4 can appropriately reduce the amount of shift in the focus position in accordance with the transition in the temperature of each of the body portion 101 and the projection lens 106 and reduce deterioration in the projection image quality.

### Another Example of Control Performed by Control Device 4

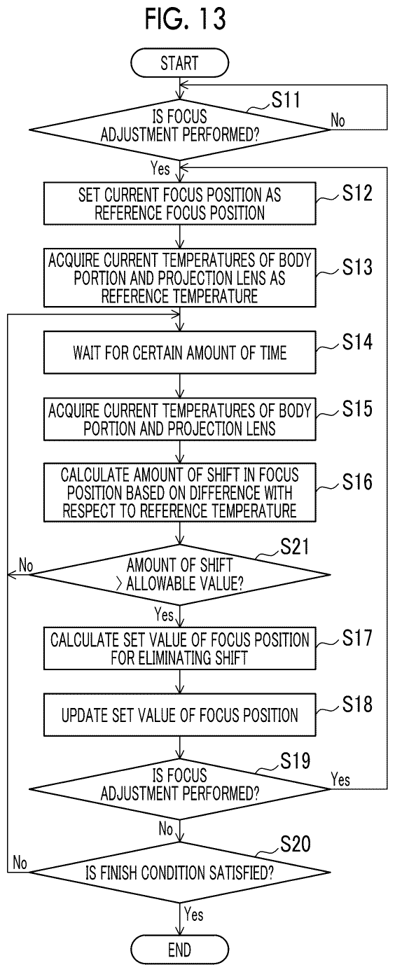

FIG. 13 is a flowchart showing another example of the control performed by the control device 4. While the example in FIG. 8 describes processing of controlling the focus position based on the temperatures of the body portion 101 and the projection lens 106 for each certain amount of time, the present invention is not limited to such processing. For example, the control device 4 may execute the processing shown in FIG. 13 instead of the processing shown in FIG. 8.

Steps S11 to S16 shown in FIG. 13 are the same as steps S11 to S16 shown in FIG. 8. In the processing shown in FIG. 13, after step S16, the control device 4 determines whether the amount of shift in the focus position calculated in step S16 exceeds a predetermined allowable value (step S21). The predetermined allowable value is, for example, a value equivalent to (corresponding to) a depth of field of the projection performed by the projection apparatus 10 and is an example of a first value.

In step S21, in a case where the amount of shift in the focus position does not exceed the predetermined allowable value (step S21: No), the control device 4 returns to step S14. In a case where the amount of shift in the focus position exceeds the predetermined allowable value (step S21: Yes), the control device 4 transitions to step S17. Steps S17 to S20 shown in FIG. 13 are the same as steps S17 to S20 shown in FIG. 8.

The control device 4 may control the focus position in a case where the amount of shift in the focus position from the set reference focus position exceeds the predetermined allowable value, and not control the focus position in a case where the amount of shift in the focus position from the set reference focus position does not exceed the predetermined allowable value. Accordingly, a frequency with which the focus position changes can be reduced, and a feeling of uneasiness given to the user can be reduced.

In the example shown in FIG. 13, the amount of time for waiting in step S14 may be reduced (to, for example, one second). In the example shown in FIG. 13, the processing may not include step S14.

### Tracking Control of Focus Position Corresponding to Amount of Shift in Focus Position

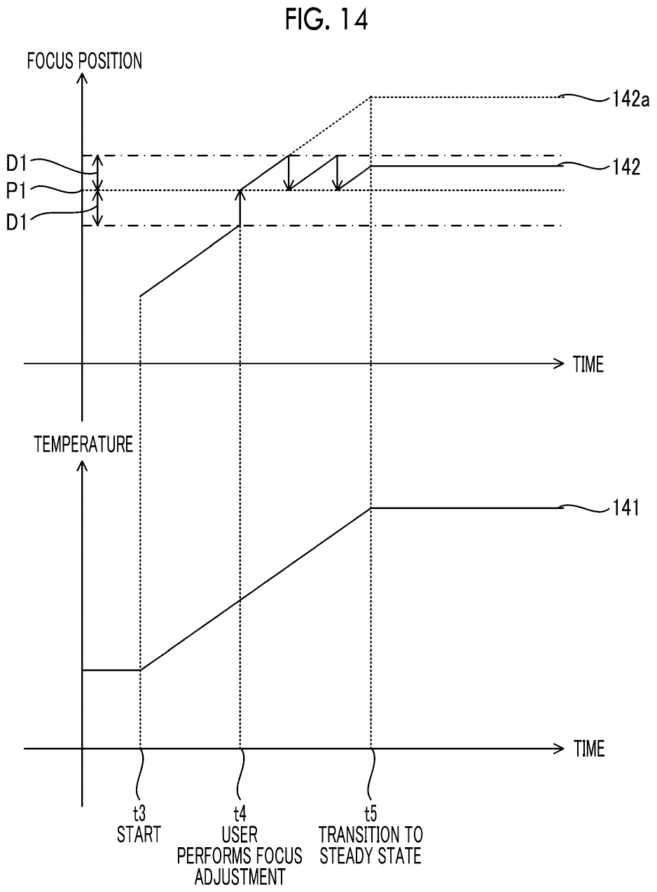

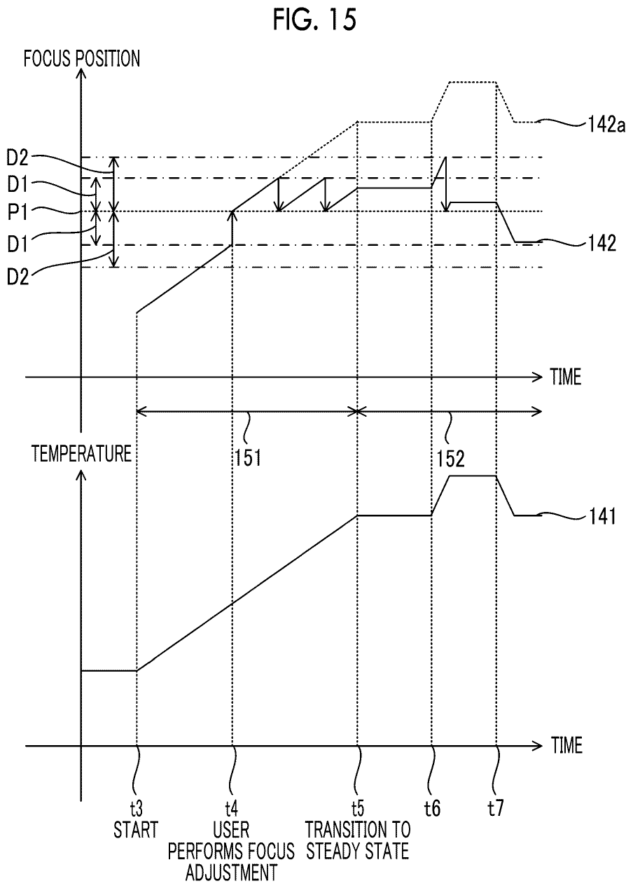

FIG. 14 is a diagram showing an example of a tracking control of the focus position corresponding to the amount of shift in the focus position. By performing the processing shown in FIG. 13 via the control device 4, the focus position is controlled as shown in, for example, FIG. 14. A transition in temperature 141 is a transition in the temperature of the projection apparatus 10 over time. A transition in focus position 142 is a transition in the focus position over time. D1 denotes the predetermined allowable value.

For example, the body portion 101 starts at time point t3, and the user performs the focus adjustment at time point t4. The temperature of the projection apparatus 10 (for both of the body portion 101 and the projection lens 106) transitions to a steady state at time point t5. In a period from time point t3 to time point t4, the focus position gradually changes in accordance with the temperature-focus position characteristic 50 as the temperature of the projection apparatus 10 increases. At time point t4, the focus position is changed by the focus adjustment performed by the user. The focus position P1 in this case is the reference focus position.

In a period from time point t4 to time point t5, the focus position gradually changes from the focus position P1 in accordance with the temperature-focus position characteristic 50. A transition in focus position 142a is a change in the focus position over time in a case where the control device 4 is assumed not to control the focus position after time point t4.

Meanwhile, in a case where the amount of shift in the focus position from the focus position P1 exceeds the allowable value D1 after time point t4, the control device 4 controls the focus position to return to the focus position P1. Accordingly, the focus position can be maintained within a range of ±D1 with respect to the focus position P1.

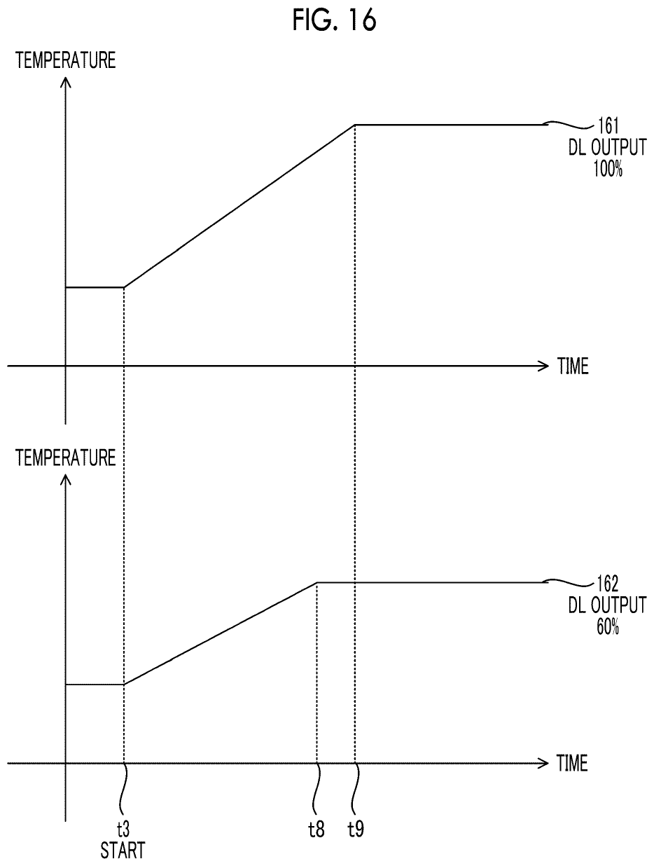

FIG. 15 is a diagram showing another example of the tracking control of the focus position corresponding to the amount of shift in the focus position. The control device 4 may change the predetermined allowable value depending on a period. For example, the control device 4 sets a period from the start of the body portion 101 to a time at which the temperature of the projection apparatus 10 transitions to a steady state (stabilizes) as a first period, and sets a period after the temperature of the projection apparatus 10 transitions to a steady state after the first period as a second period.

For example, based on the output value of the temperature sensor provided in the body portion 101, the control device 4 sets a period from the start of the body portion 101 to a time at which an amount of change in the output value of the temperature sensor per unit time reaches a threshold value or lower, as the first period and sets a period from the time at which the amount of change in the output value of the temperature sensor per unit time reaches the threshold value or lower, as the second period.

For example, in the example in FIG. 15, a period from time point t3 to time point t5 is a first period 151, and a period from time point t5 is a second period 152. In the example in FIG. 15, the temperature of the projection apparatus 10 is temporarily high in a period from time point t6 to time point t7 in the second period 152. Such a change in the temperature may occur because of, for example, a change in the temperature of the space in which the projection apparatus 10 is installed, or a change in a processing load of the body portion 101.

For example, in the first period 151, the control device 4 controls the focus position to return to the focus position P1 in a case where the absolute amount of shift in the focus position from the focus position P1 exceeds the allowable value D1. Meanwhile, in the second period 152, the control device 4 controls the focus position to return to the focus position P1 in a case where the absolute amount of shift in the focus position from the focus position P1 exceeds an allowable value D2 that is greater than the allowable value D1. The allowable value D2 is, for example, a value equivalent to α×D (α>1) and is an example of a second value.

For example, during the increase in the temperature of the projection apparatus 10 from time point t6, the control device 4 does not control the focus position when the absolute amount of shift in the focus position from the focus position P1 exceeds the allowable value D1. When the absolute amount of shift in the focus position from the focus position P1 exceeds the allowable value D2, the control device 4 controls the focus position to return to the focus position P1.

Then, the temperature of the projection apparatus 10 further increases, but the control device 4 does not control the focus position because the absolute amount of shift in the focus position from the focus position P1 does not exceed the allowable value D2. Then, after time point t7, the temperature of the projection apparatus 10 decreases and returns to a steady state, but the control device 4 does not control the focus position because the absolute amount of shift in the focus position from the focus position P1 does not exceed the allowable value D2.

In the second period 152, the allowable value for the absolute amount of shift in the focus position from the focus position P1 is increased. Accordingly, hunting caused by controlling the focus position to excessively track the transition in the temperature of the projection apparatus 10 can be reduced.

While a configuration in which the control device 4 sets the first period 151 and the second period 152 based on the output value of the temperature sensor provided in the body portion 101 is described, the present invention is not limited to such a configuration. For example, as long as a time required for the temperature of the body portion 101 to transition to a steady state after the body portion 101 starts is substantially constant as a time Δt, the control device 4 may set a period of an elapse of the time Δt from the start of the body portion 101 as the first period 151 and set a period after the elapse of the time Δt as the second period 152.

### Difference in Transition in Temperature of Projection Apparatus 10 Depending on Output State of Light Source 21

FIG. 16 is a diagram showing an example of a difference in the transition in the temperature of the projection apparatus 10 depending on an output state of the light source 21. A transition in temperature 161 is a transition in the temperature of the projection apparatus 10 over time in a case where output power of the light source 21 is 100%. In the transition in temperature 161, the temperature of the projection apparatus 10 transitions to a steady state at time point t9. That is, in a case where the output power of the light source 21 is 100%, the time required for the temperature of the projection apparatus 10 to transition to a steady state after the body portion 101 starts is a time equivalent to t9−t3.

A transition in temperature 162 is a transition in the temperature of the projection apparatus 10 over time in a case where the output power of the light source 21 is 60%. In the transition in temperature 162, the temperature of the projection apparatus 10 transitions to a steady state at time point t8 before time point t9. That is, in a case where the output power of the light source 21 is 60%, the time required for the temperature of the projection apparatus 10 to transition to a steady state after the body portion 101 starts is a time equivalent to t8−t3.

As described above, in a configuration in which the period of the elapse of the time Δt from the start of the body portion 101 is set as the first period 151, and the period after the elapse of the time Δt is set as the second period 152, the control device 4 may change the time Δt in accordance with the output power of the light source 21. The output power of the light source 21 is an example of an output state of the light source device.

For example, the memory 4a stores correspondence information (a correspondence table or function) between the output power of the light source 21 and the time Δt from the start of the body portion 101 to the time at which the temperature of the projection apparatus 10 transitions to a steady state. The control device 4 may set the time Δt based on the correspondence information and the output power of the light source 21 and set the first period 151 and the second period 152 based on the set time Δt.

### Controlling Focus Position Based on Pixel Value of Image Data Used for Projection

The control device 4 may control the focus position based on pixel values of image data used for the projection. The image data used for the projection is data of an image (a still image or a moving image) of content to be projected and is, for example, the image data used for the modulation in the optical modulation portion 22.

For example, in a case where the image data is RGB data, as an average value of pixel values of the image data (for example, an average value of each pixel value of RGB of all pixels) increases (comes closer to that of a white image), a quantity of the projection light incident on the projection lens 106 increases, and the temperature of the projection lens 106 is more likely to increase. Meanwhile, even in a case where the average value of the pixel values of the image data is high, a state of the light source 21 or the processor that is a main heat source does not change. Thus, the temperature of the body portion 101 does not change as much as the temperature of the projection lens 106.

That is, a change in the temperature caused by the pixel values of the image data used for the projection is more significant in the projection lens 106 than in the body portion 101. Thus, the temperature of the projection lens 106 estimated based on the output value of the temperature sensor provided in the body portion 101 or the amount of shift in the focus position calculated based on the temperature includes error corresponding to a change in the temperature caused by the pixel values.

To correct this error, the control device 4, for example, corrects the amount of shift in the focus position, which is based on the temperature of the projection lens 106 estimated based on the temperature of the body portion 101 and the temperature-focus position characteristic 52, using the average value of the pixel values of the image data used for the projection. The control device 4 calculates the amount of shift in the focus position as a whole including the body portion 101 based on the corrected amount of shift in the focus position and controls the focus position based on the calculated amount of shift.

Alternatively, the control device 4 may correct the temperature of the projection lens 106 estimated based on the temperature of the body portion 101 using the average value of the pixel values of the image data used for the projection. The control device 4 may calculate the amount of shift in the focus position based on the corrected temperature of the projection lens 106 and the temperature-focus position characteristic 52, calculate the amount of shift in the focus position as a whole including the body portion 101 based on the calculated amount of shift in the focus position, and control the focus position based on the calculated amount of shift.

For example, a correction value (a correction value of the amount of shift in the focus position or a correction value of the temperature) for correcting error in a case where an average pixel value (the average value of the pixel values) of the image data is assumed to be a maximum value Max (for example, 255) is denoted by Pw, and a correction value for correcting error in a case where the average pixel value of the image data is assumed to be a minimum value of 0 is 0. In this case, the correction value of the amount of shift in the focus position (or the correction value of the temperature of the projection lens 106) with respect to the actual average pixel value of the image data can be set as Pw×(average pixel value)/Max.

### Controlling Focus Position Based on Pixel Value of Image Data Used for Projection

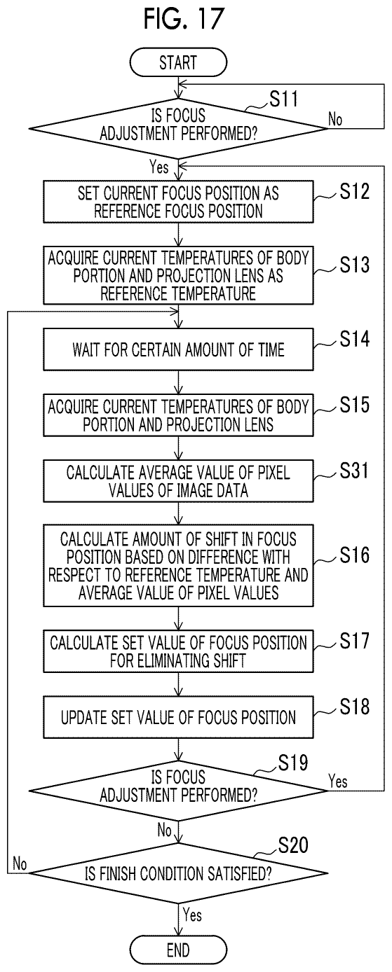

FIG. 17 is a flowchart showing an example of controlling the focus position based on the pixel values of the image data used for the projection. For example, the control device 4 may execute the processing shown in FIG. 17. Steps S11 to S15 shown in FIG. 17 are the same as steps S11 to S15 shown in FIG. 8. After step S15, the control device 4 calculates the average value of the pixel values of the image data used for the projection (step S31) and transitions to step S16.

The pixel values of the image data used for the projection may be image data input into the optical modulation unit 12 at the moment, image data input into the optical modulation unit 12 a certain amount of time ago, or image data scheduled to be input into the optical modulation unit 12 after a certain amount of time.

Steps S16 to S20 shown in FIG. 17 are the same as steps S16 to S20 shown in FIG. 8. However, in step S16 shown in FIG. 17, the control device 4 calculates the amount of shift in the focus position of the projected image of the projection apparatus 10 based on the average value of the pixel values of the image data calculated in step S31 in addition to the difference between the temperature acquired in step S15 and the reference temperature acquired in step S13.

The control device 4 may control the focus position based on the pixel values of the image data used for the projection. Accordingly, error in the amount of shift in the focus position caused by the change in the temperature of the projection lens 106 can be corrected in accordance with the pixel values of the image data used for the projection, and the amount of shift in the focus position can be appropriately reduced in accordance with the change in the temperature of each of the body portion 101 and the projection lens 106.

### Weighting Pixel Value Corresponding to Area of Image Data

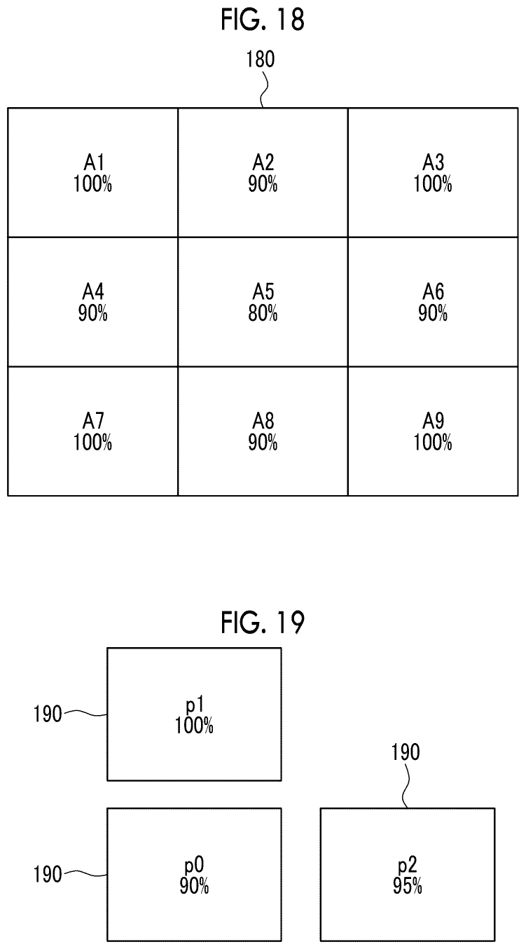

FIG. 18 is a diagram showing an example of weighting pixel values corresponding to an area of the image data. A pixel area 180 is an area of an image indicated by the image data. Controlling the focus position based on the pixel values of the image data used for the projection is equivalent to controlling the focus position based on pixel values of pixels included in the pixel area 180.

For example, depending on a position in the pixel area 180, which position the projection light corresponding to the position passes through in the lens included in the projection lens 106 (for example, which of a center portion or an edge portion the projection light passes through) varies. Accordingly, an effect of the change in the temperature of the projection lens 106 on the focus position may vary. To correct this, the control device 4 may weight the pixel values of the pixels included in the pixel area 180 in accordance with a position in the image (the pixel area 180) indicated by the image data and control the focus position based on the weighted pixel values.

For example, division areas A1 to A9 are set in the pixel area 180, and weight coefficients are set for each of the division areas A1 to A9. For example, weight coefficient=80% is set for the division area A5 at a center, weight coefficient=90% is set for the division areas A2, A4, A6, and A8 adjacent to the division area A5 on upper, lower, left, and right sides, and weight coefficient=100% is set for the division areas A1, A3, A7, and A9 at four corners. These weighting coefficients are stored in advance in, for example, the memory 4a.

For example, in calculating the average value of the pixel values of each pixel of the pixel area 180 in step S31 shown in FIG. 17, the control device 4 calculates a weighted average value of the pixel values by multiplying the average value by a weight coefficient set for a division area to which a target pixel belongs among the division areas A1 to A9. For example, the control device 4 calculates a weighted average value of the pixel values using Equation (1). Here, n is the number of division areas, and n=9 is established in the example in FIG. 17. An is an average pixel value of an n-th division area. Xn is a weight coefficient set for the n-th division area.

Weighted average value=1/n×Σ(An×Xn) (1)

Accordingly, error in the amount of shift in the focus position caused by the change in the temperature of the projection lens 106 can be corrected by taking into consideration a difference in the effect of the change in the temperature of the projection lens 106 on the focus position depending on the position in the pixel area 180.

In the example in FIG. 18, a higher weight coefficient is set as the pixel is closer to the edge portion. However, the present invention is not limited to such a setting. Depending on the configuration of the projection lens 106, a lower weight coefficient may be set as the pixel is closer to the edge portion.

### Weighting Pixel Value Corresponding to Optical Shift Position in Projection

FIG. 19 is a diagram showing an example of weighting pixel values corresponding to an optical shift position in the projection. A projection image 190 corresponds to the pixel area 180 and is the projection image projected to the projection object 6. The control device 4 can optically shift the projection image 190 in a direction orthogonal to the projection direction for the projection object 6 via the optical system shift mechanism. In the example in FIG. 19, the projection image 190 can be optically shifted to at least optical shift positions p0 to p2. The optical shift position p0 is a position without a shift.

For example, depending on the optical shift position of the projection image 190, which position the projection light corresponding to the position passes through in the lens included in the projection lens 106 (for example, which of a center portion or an edge portion the projection light passes through) varies. Accordingly, the effect of the change in the temperature of the projection lens 106 on the focus position may vary. To correct this, the control device 4 may control the focus position based on the optical shift position of the projection image 190 in the projection.

In the example in FIG. 19, weight coefficient=90% is set for the optical shift position p0 without an optical shift, weight coefficient=100% is set for the optical shift position p1, and weight coefficient=95% is set for the optical shift position p2. These weighting coefficients are stored in advance in, for example, the memory 4a.

For example, in calculating the average value of the pixel values of each pixel of the pixel area 180 in step S31 shown in FIG. 17, the control device 4 calculates the average value of the pixel values by multiplying the average value by a weight coefficient set for the current optical shift position. Accordingly, error in the amount of shift in the focus position caused by the change in the temperature of the projection lens 106 can be corrected by taking into consideration a difference in the effect of the change in the temperature of the projection lens 106 on the focus position depending on the optical shift position of the projection image 190.

### Controlling Focus Position Based on Transition in Pixel Value of Image Data

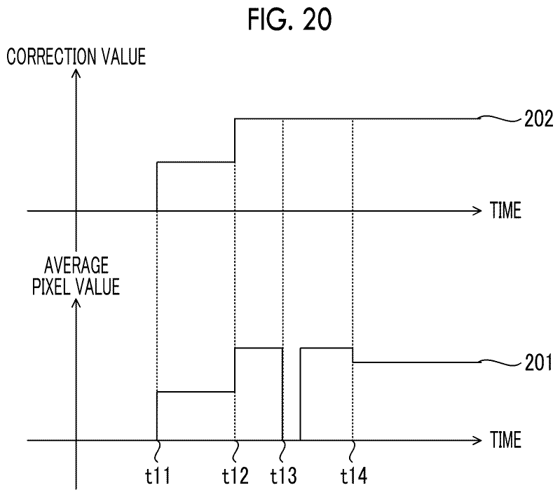

FIG. 20 is a diagram for describing an example of controlling the focus position based on a transition in the pixel values of the image data. The control device 4 may control the focus position based on the pixel values of the image data using the transition in the pixel values of the image data. For example, the control device 4 may control the focus position in a case where the transition in the pixel values of the image data satisfies a first condition, and not control the focus position (maintain the set value of the focus position) in a case where the transition in the pixel values of the image data does not satisfy the first condition.

The transition in the pixel values of the image data may be a transition in the pixel values of the image data projected for a certain period from the past to the present or a transition in the pixel values of the image data to be projected for a certain period from the present to the future. The transition in the pixel values of the image data may be a transition in the pixel values of the image data projected in a period obtained by combining the certain period from the past to the present and the certain period from the present to the future.

The first condition includes, for example, a condition that a certain amount of change (change per time) or more occurs in the average pixel value. The first condition may also include a condition that the average pixel value changes, and the average pixel value after change continues for a certain amount of time or longer.

For example, in FIG. 20, a transition in average pixel value 201 is an example of a change in the pixel values of the image data over time. A transition in correction value 202 is an example of a change in the correction value (the correction value of the amount of shift in the focus position or the correction value of the temperature) corresponding to the transition in average pixel value 201.

The control device 4 sets the correction value of the amount of shift in the focus position or the correction value of the temperature as described above in accordance with the transition in average pixel value 201. In this example, the control device 4 changes the correction value to track a change in the average pixel value such that the correction value increases as the average pixel value increases. However, in a case where the transition in the average pixel value does not satisfy the first condition, the control device 4 does not cause the correction value to track a change in the average pixel value. In the example in FIG. 20, the first condition is the condition that the certain amount of change (change per time) or more occurs in the average pixel value, and the average pixel value after change continues for the certain amount of time or longer.

For example, in the example in FIG. 20, as shown in the transition in average pixel value 201, the average pixel value significantly increases at time point t11, and the average pixel value after increase continues for the certain amount of time or longer. In this case, as shown in the transition in correction value 202, the control device 4 also increases the correction value by tracking the increase in the average pixel value at time point t11.

As shown in the transition in average pixel value 201, the average pixel value further significantly increases at time point t12, and the average pixel value after increase continues for the certain amount of time or longer. In this case, as shown in the transition in correction value 202, the control device 4 also increases the correction value by tracking the increase in the average pixel value at time point t12.

As shown in the transition in average pixel value 201, the average pixel value significantly decreases at time point t13, and the decreased average pixel value is restored in less than the certain amount of time. In this case, as shown in the transition in correction value 202, the control device 4 maintains the correction value without tracking the decrease in the average pixel value at time point t13.

As shown in the transition in average pixel value 201, the average pixel value decreases at time point t14, and an amount of decrease in the average pixel value is less than a certain amount. In this case, as shown in the transition in correction value 202, the control device 4 maintains the correction value without tracking the decrease in the average pixel value at time point t14.

In the example in FIG. 20, the control device 4 causes the correction value to track a change in the average pixel value substantially without delay. Thus, the control device 4 can determine whether the changed average pixel value continues for the certain amount of time or longer by reading the image data after the certain amount of time or longer from the present.

However, the present invention is not limited to such a configuration, and the control device 4 may be configured to cause the correction value to track a change in the average pixel value with a delay of a certain amount of time. In this case, the control device 4 can set the correction value while reading the current image data as a projection target.

### Notification of Shift in Focus Position Caused by Transition in Temperature

While a configuration in which the control device 4 controls the focus position of the projection apparatus 10 based on the temperature of the projection apparatus 10 is described, the present invention is not limited to such a configuration. For example, the control device 4 may be configured to calculate the amount of shift in the focus position of the projection apparatus 10 based on the temperature of the projection apparatus 10 and perform a control of notifying the user of information indicating the calculated amount of shift. For example, this notification can be performed by the projection performed by the projection apparatus 10.

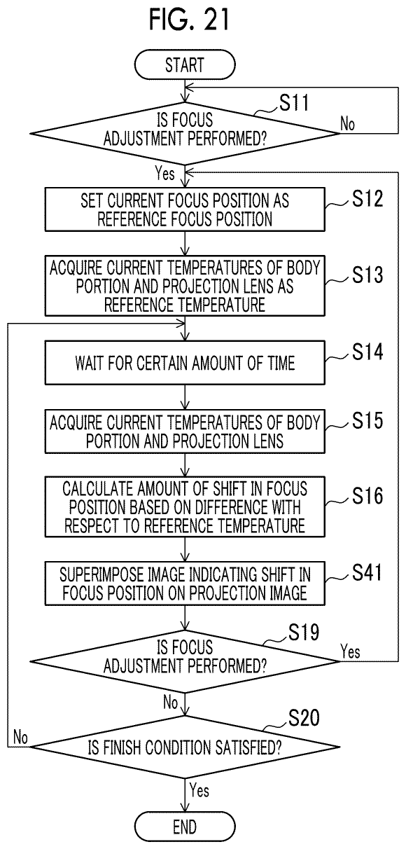

FIG. 21 is a flowchart showing an example of processing of providing notification of a shift in the focus position caused by the transition in the temperature. For example, the control device 4 may execute the processing shown in FIG. 21 instead of the processing shown in FIG. 8. Steps S11 to S16 shown in FIG. 21 are the same as steps S11 to S16 shown in FIG. 8.

In the processing shown in FIG. 21, after step S16, the control device 4 superimposes an image indicating a shift in the focus position on the projection image of the projection apparatus 10 based on the calculation result in step S16 (step S41). The image can be superimposed on the projection image by performing image processing on the image data input into the optical modulation unit 12.

After step S41, the control device 4 transitions to step S19. Steps S19 and S20 shown in FIG. 21 are the same as steps S19 and S20 shown in FIG. 8.

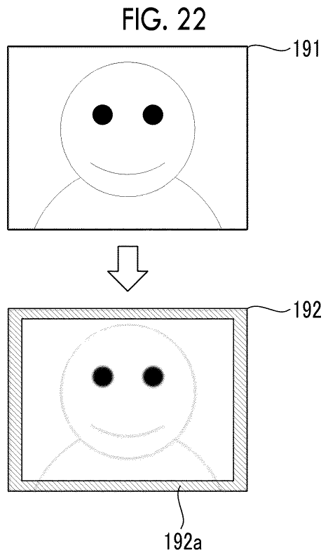

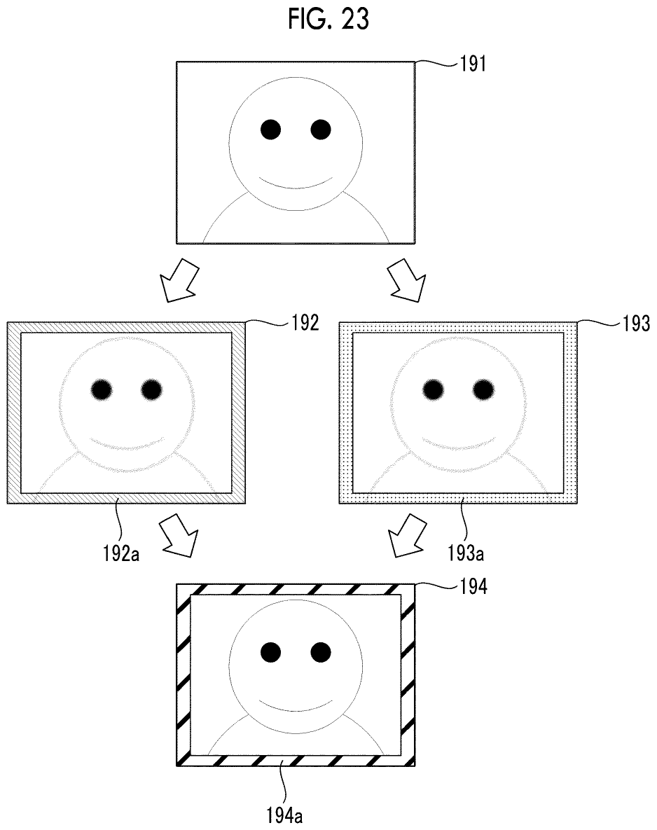

FIG. 22 is a diagram showing an example of notification of a shift in the focus position caused by the transition in the temperature. A projection image 191 shown in FIG. 22 is a projection image projected to the projection object 6 immediately after the user performs the focus adjustment. In the processing shown in FIG. 21, the control device 4, for example, does not superimpose the image indicating a shift on the projection image 191 because the focus position of the projection image 191 does not shift with respect to the projection object 6.

A projection image 192 is a projection image projected in a state where the focus position is shifted with respect to the projection object 6 because of a change in the temperature of the projection apparatus 10 after the user performs the focus adjustment. In this case, the control device 4 recognizes that the focus position is shifted based on the calculation result in step S16 shown in FIG. 21, and superimposes a frame image 192a on the projection image 192. The frame image 192a is an example of an image indicating that the focus position is shifted. Accordingly, the user can recognize that the focus position is shifted from the state where the focus adjustment is performed, and be prompted to perform the focus adjustment again.

In the example shown in FIG. 22, the frame image 192a may be an image indicating not only a shift in the focus position but also the absolute amount of shift in the focus position. For example, the control device 4 may superimpose the frame image 192a having a different color or density on the projection image 192 depending on a magnitude of the absolute amount of shift in the focus position calculated in step S16.

FIG. 23 is a diagram showing another example of notification of a shift in the focus position caused by the transition in the temperature. The same parts as the parts shown in FIG. 22 will be designated by the same reference numerals in FIG. 23 and will not be described. A projection image 193 shown in FIG. 23 is a projection image projected in a state where the focus position is shifted in an opposite direction to that of the projection image 192 because of the change in the temperature of the projection apparatus 10 after the user performs the focus adjustment.

For example, the projection image 192 is the projection image in a case where the focus position is shifted to a back side (a side opposite to the projection apparatus 10) with respect to the projection surface of the projection object 6, and a projection image 193 is a projection image in a case where the focus position is shifted to a front side (a side on which the projection apparatus 10 is present) with respect to the projection surface of the projection object 6.

The control device 4 may also superimpose a frame image 193a on the projection image 193 in a case where the focus position is shifted to the front side, like the frame image 192a of the projection image 192 in a case where the focus position is shifted to the back side.

The control device 4 may use images having different aspects as the frame image 192a of the projection image 192 in a case where the focus position is shifted to the back side, and the frame image 193a of the projection image 193 in a case where the focus position is shifted to the front side. The different aspects are, for example, different aspects that can be distinguished by the user even in a case where the projection image is blurred, such as different colors or different patterns.

For example, the control device 4 sets a red frame image as the frame image 192a of the projection image 192 in a case where the focus position is shifted to the back side, and sets a yellow frame image as the frame image 193a of the projection image 193 in a case where the focus position is shifted to the front side. Accordingly, the user can recognize a direction in which the focus position is shifted, and efficiently perform the focus adjustment again.

In FIG. 23, a projection image 194 is a projection image projected in a state where the user performs the focus adjustment again from the projection image 192 or the projection image 193, and a shift in the focus position with respect to the projection object 6 is eliminated.

The control device 4 may superimpose a frame image 194a on the projection image 194 in a case where a shift in the focus position is eliminated by performing the focus adjustment again. The frame image 194a is an image having a different aspect from the frame images 192a and 193a. For example, the control device 4 sets green frame images as the frame images 192a and 193a. Accordingly, the user can recognize that a shift in the focus position is eliminated, and efficiently perform the focus adjustment again.

The control device 4 may not superimpose the frame image 194a on the projection image 194 in a case where a shift in the focus position is eliminated by performing the focus adjustment again. Even in such a configuration, the user can recognize that a shift in the focus position is eliminated, and efficiently perform the focus adjustment again.

### Modification Example

While FIGS. 3 and 4 describe a configuration in which the optical axis K does not bend as the configuration of the projection apparatus 10, the optical axis K may be configured to bend once or more by providing a reflective member in the projection lens 106.

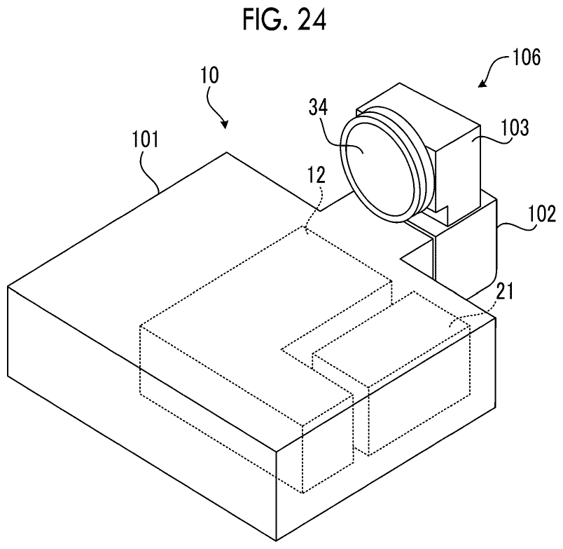

FIG. 24 is a diagram showing another example of the exterior configuration of the projection apparatus 10. FIG. 25 is a cross-sectional view of the projection lens 106 of the projection apparatus 10 shown in FIG. 24. The same parts as the parts shown in FIGS. 3 and 4 will be designated by the same reference numerals in FIGS. 24 and 25 and will not be described.

As shown in FIG. 24, the projection lens 106 comprises a second member 103 supported by the first member 102, in addition to the first member 102 supported by the body portion 101. The first member 102 and the second member 103 may be an integrated member.

As shown in FIG. 25, the projection lens 106 comprises, in addition to the first member 102, the second member 103 including a hollow portion 3A connected to the hollow portion 2A of the first member 102; the first optical system 121 and a reflective member 122 disposed in the hollow portion 2A; a second optical system 31, a reflective member 32, a third optical system 33, and the lens 34 disposed in the hollow portion 3A; the first shift mechanism 105; and a projection direction changing mechanism 104.

In the example in FIGS. 24 and 25, the opening 2a and the opening 2b of the first member 102 are formed in surfaces perpendicular to each other. The optical projection system 23 shown in FIGS. 24 and 25 is composed of the reflective member 122, the second optical system 31, the reflective member 32, and the third optical system 33, in addition to the first optical system 121 and the lens 34 shown in FIGS. 3 and 4. By providing the optical projection system 23, the optical axis K is formed to fold by bending twice, as shown in FIG. 25. The first optical system 121, the reflective member 122, the second optical system 31, the reflective member 32, the third optical system 33, and the lens 34 are disposed in this order from a side on which the optical modulation portion 22 is present, along the optical axis K.

The first optical system 121 guides light incident on the first member 102 from the body portion 101 and traveling in the direction X1 to the reflective member 122. The reflective member 122 reflects light incident from the first optical system 121 in the direction Y1. The reflective member 122 is composed of, for example, a mirror. In the first member 102, the opening 2b is formed on an optical path of light reflected by the reflective member 122, and the reflected light travels to the hollow portion 3A of the second member 103 by passing through the opening 2b.

The second member 103 is a member of which a cross-sectional external shape is substantially L-shaped, in which an opening 3a is formed at a position facing the opening 2b of the first member 102. Light that has passed through the opening 2b of the first member 102 from the body portion 101 is incident into the hollow portion 3A of the second member 103 through the opening 3a. The first member 102 and the second member 103 may have any cross-sectional external shapes and are not limited to the above cross-sectional external shapes.

The second optical system 31 includes at least one lens and guides light incident from the first member 102 to the reflective member 32. The reflective member 32 guides light incident from the second optical system 31 to the third optical system 33 by reflecting the light to the direction X2. The reflective member 32 is composed of, for example, a mirror. The third optical system 33 includes at least one lens and guides light reflected by the reflective member 32 to the lens 34.

The lens 34 is disposed in an end portion of the second member 103 on a side in the direction X2, in the form of closing the opening 3c formed in the end portion. The lens 34 projects light incident from the third optical system 33 to the projection object 6.

FIG. 25 shows a state where the first member 102 is moved as far as possible to the side in the direction Y1 by the first shift mechanism 105. By moving the first member 102 in the direction Y2 via the first shift mechanism 105 from the state shown in FIG. 25, the relative position between the center of the image formed by the optical modulation portion 22 and the optical axis K is changed, and the image G1 projected to the projection object 6 can be shifted in the direction Y1.

The projection direction changing mechanism 104 is a rotation mechanism that rotatably connects the second member 103 to the first member 102. By providing the projection direction changing mechanism 104, the second member 103 is configured to be rotatable about a rotation axis (specifically, the optical axis K) that extends in the direction Y. The projection direction changing mechanism 104 is not limited to the disposition position shown in FIG. 25 as long as the projection direction changing mechanism 104 can rotate the optical system. The number of rotation mechanisms is not limited to one, and a plurality of rotation mechanisms may be provided.

### Program and Processor

In the present embodiment, each type of processing is executed by any computer. Any computer may execute these types of processing via a processor as hardware, a program as software, or a combination thereof. In that case, the processor may be configured to execute various types of processing in the present embodiment in cooperation with the program or may function as each unit or each means in the present embodiment. An execution order of the processing performed by the processor is not limited to the above order and may be changed, as appropriate. Any computer may be a general-purpose computer, a computer for specific purposes, a workstation, or other systems capable of executing each type of processing.

The processor may be composed of one or a plurality of pieces of hardware, and a type of hardware is not limited. For example, the processor may be composed of hardware such as a central processing unit (CPU), a micro processing unit (MPU), a programmable logic device such as a field programmable gate array (FPGA), a dedicated circuit for executing a specific type of processing, such as an application specific integrated circuit (ASIC), a graphic processing unit (GPU), or a neural processing unit (NPU). The type of hardware may be a combination of different types of hardware. In a case where a plurality of pieces of hardware are configured to execute any one or a plurality of types of processing of the processor, the plurality of pieces of hardware may be present in apparatuses physically separated from each other or may be present in the same apparatus. In any embodiment, an order of each type of processing performed by the processor is not limited to the above order and may be changed, as appropriate. The hardware is composed of an electric circuit (circuitry) in which circuit elements such as semiconductor elements are combined.

The program may be software such as firmware or a microcode. For example, the program may be a program module group, and each function thereof may be implemented by the processor configured to execute each function. The program may be a program code or a plurality of code segments stored in one or a plurality of non-transitory computer-readable media (for example, storage media or other storages). The program may be divided and stored in a plurality of non-transitory computer-readable media present in apparatuses physically separated from each other. The program code or the code segments may indicate any combination of a procedure, a function, a subprogram, a routine, a subroutine, a module, a software package, a class, an instruction, a data structure, and a program statement. The program code or the code segments may be connected to other code segments or a hardware circuit by transmitting and receiving information, data, an argument, a parameter, or content of a memory.

The present invention can also be applied to a program and a program product.

### EXPLANATION OF REFERENCES

1: projection portion
2: operation reception portion
2A, 3A: hollow portion
2a, 2b, 3a, 3c, 15a: opening
4: control device
4a: memory
6: projection object
10: projection apparatus
11, 11a: projection range
12: optical modulation unit
15: housing
21: light source
22: optical modulation portion
23: optical projection system
24: control circuit
31: second optical system
32, 122: reflective member
33: third optical system
34: lens
50 to 52: temperature-focus position characteristic
91, 92, 141, 161, 162: transition in temperature
93, 111, 112, 142, 142a: transition in focus position
101: body portion
102: first member
103: second member
104: projection direction changing mechanism
105: first shift mechanism
106: projection lens
121: first optical system
151: first period
152: second period
180: pixel area
190 to 194: projection image
192a, 193a, 194a: frame image
201: transition in average pixel value
202: transition in correction value
A1 to A9: division area
D1, D2: allowable value
G1: image
P1 to P4: focus position
T1 to T4: temperature
p0 to p2: optical shift position
t0 to t8, t11 to t14, t21: time point

What is claimed is:

1. A projection apparatus comprising:
a body portion that performs projection through a projection lens; and
a processor,
wherein the processor is configured to:
control, in a first temperature range, a focus position of a projection image in accordance with first temperature characteristic information indicating a relationship between the focus position and a temperature of the body portion and second temperature characteristic information indicating a relationship between the focus position and a temperature of the projection lens; and
control, in a second temperature range, the focus position in accordance with temperature characteristic information of either the first temperature characteristic information or the second temperature characteristic information.

2. The projection apparatus according to claim 1,
wherein the first temperature characteristic information indicates a relationship between a change in the temperature of the body portion and a change in the focus position, and
the second temperature characteristic information indicates a relationship between a change in the temperature of the projection lens and a change in the focus position.

3. The projection apparatus according to claim 2,
wherein the processor is configured to:
control, in the first temperature range, the focus position based on a first change in the focus position based on the change in the temperature of the body portion and the first temperature characteristic information and a second change in the focus position based on the change in the temperature of the projection lens and the second temperature characteristic information; and
control, in the second temperature range, the focus position in accordance with either the first change or the second change.

4. The projection apparatus according to claim 1,
wherein the processor is configured to control the focus position to reduce an amount of shift in the focus position corresponding to a change in at least one of the temperature of the body portion or the temperature of the projection lens.

5. The projection apparatus according to claim 4,
wherein the processor is configured to reduce the amount of shift from a first focus position of the projection image set by a user.

6. The projection apparatus according to claim 5,
wherein the processor is configured to control the focus position in a case where the amount of shift from the first focus position exceeds a first value.

7. The projection apparatus according to claim 6,
wherein the first value is a value corresponding to a depth of field of the projection.

8. The projection apparatus according to claim 7,
wherein the processor is configured to:
control, in a first period, the focus position in a case where the amount of shift from the first focus position exceeds the first value; and
control, in a second period, the focus position in a case where the amount of shift from the first focus position exceeds a second value that is greater than the first value.

9. The projection apparatus according to claim 8,
wherein the second period is a period after the first period.

10. The projection apparatus according to claim 9,
wherein the first period is a period from a start of the body portion to stabilization of the temperature of the body portion.

11. The projection apparatus according to claim 9,
wherein the body portion includes a light source device, and
the processor is configured to set the first period and the second period in accordance with an output state of the light source device.

12. The projection apparatus according to claim 1,
wherein the processor is configured to control the focus position based on a pixel value of image data used for the projection.

13. The projection apparatus according to claim 12,
wherein the processor is configured to control the focus position based on the pixel value weighted in accordance with a position in an image indicated by the image data.

14. The projection apparatus according to claim 12,
wherein the processor is configured to control the focus position based on an optical shift position in the projection.

15. The projection apparatus according to claim 12,
wherein the processor is configured to control the focus position in a case where a transition in the pixel value satisfies a first condition.

16. A control method performed by a processor of a projection apparatus, wherein
the projection apparatus includes a body portion that performs projection through a projection lens, and the processor, and
the control method comprises:
controlling, in a first temperature range, a focus position of a projection image in accordance with first temperature characteristic information indicating a relationship between the focus position and a temperature of the body portion and second temperature characteristic information indicating a relationship between the focus position and a temperature of the projection lens; and
controlling, in a second temperature range, the focus position in accordance with temperature characteristic information of any one of the first temperature characteristic information or the second temperature characteristic information.

17. A non-transitory computer-readable storage medium storing a control program causing a processor of a projection apparatus including a body portion that performs projection through a projection lens, and the processor, to execute a process comprising:
controlling, in a first temperature range, a focus position of a projection image in accordance with first temperature characteristic information indicating a relationship between the focus position and a temperature of the body portion and second temperature characteristic information indicating a relationship between the focus position and a temperature of the projection lens; and
controlling, in a second temperature range, the focus position in accordance with temperature characteristic information of any one of the first temperature characteristic information or the second temperature characteristic information.
